(19) United States
(12) Patent Application Publication
(10) Pub. No.: US 2008/0219468 A1
(43) Pub. Date: Sep. 11, 2008

(54) APPARATUS FOR TRANSMITTING SOUND TO A FETUS

(76) Inventors: Curtis Mark Williams, Los Angeles, CA (US); Brett Klisch, Brooklyn, NY (US)

Correspondence Address: PRYOR CASHMAN, LLP, 410 PARK AVENUE, NEW YORK, NY, 10022, US

(21) Appl. No.: 12/042,476

(22) Filed: Mar. 5, 2008

Related U.S. Application Data
(60) Provisional application No. 60/904,843, filed on Mar. 5, 2007.

(51) Int. Cl. H04B 3/00

(52) U.S. Cl. 381/77

(57) ABSTRACT

An apparatus for delivering sound to a fetus through a pregnant woman's abdomen. In a preferred embodiment, the apparatus utilizes limited-volume, modular sound transmitters encased in housings which are affixed on their undersides with a compound that safety adheres each transmitter to any appropriate location on the outer wall of the abdomen. The transmitters and their respective housings are connected to each other electronically at one end by an audio plug, not unlike commercial headphones, where is situated an additional audio jack meant for the purpose of simultaneous listening. An external case holds the housings together when not in use thereby protecting the adhesive compound from the elements. Alternatively, the apparatus may include shells adapted to receive commercially available sound transmitters such as ear buds.

### RELATED APPLICATIONS

Domestic priority is claimed from U.S. Provisional Patent Application No. 60/904,843 entitled “Apparatus for Transmitting Sound”, filed Mar. 5, 2007, the teachings of which are incorporated by reference herein.

### BACKGROUND OF THE INVENTION

1. Field of the Invention

This invention generally relates to methods and apparatus for providing auditory stimulation to a fetus in utero, specifically to a simplified, more portable means of delivering such stimulation with a device that employs independent, modular sound transmitters that adhere to the abdomen area of a pregnant woman.

2. Description of Related Art

The use of audio fetal stimulation devices is known in the prior art. There have been numerous devices developed for conveying sounds to a fetus through a mother's abdomen using sound transmitters. Known prior art includes U.S. Pat. U.S. Pat. No. 4,934,998; U.S. Pat. No. 5,109,421; U.S. Pat. No. 5,699,558; U.S. Pat. No. 5,913,834; U.S. Pat. No. 5,873,736; U.S. Pat. No. 6,169,814; U.S. Pat. No. 6,718,044; and U.S. Pat. No. 6,840,775.

All prior art, however, barring none of the above referenced, involves the use of a belt or strap system that wraps completely around the waist of the mother as the means to hold fixed sound transmitters(s) to the abdomen area. In addition to excess weight and bulkiness and subsequent higher manufacturing costs, this method is cumbersome and conspicuous and not a viable option for athletic, working and/or fashion conscious mothers.

The prior art is also limited in its ability to accurately and most advantageously direct sounds toward the fetus as the speaker positions claimed therein are limited in their ability to be placed anywhere on the abdomen. As the mother is able to determine where and how her child is positioned in her womb, so should she be able to freely determine the best place to rest sound transmitters against her abdomen to most accurately reach the child. Furthering the need for modular transmitters, recent research has reported the use of sounds not only for the stimulation of the fetus, but as a means to help rectify an impending breech birth by placing transmitters on the underside of a mother's abdomen thereby enticing the fetus to move its head down toward the sounds resulting in a more advantageous birthing position. U.S. Pat. No. 6,840,775 attempts to improve upon previous audio fetal stimulation devices in this regard by allowing the user to slide the transmitters anywhere along the belt to thusly more effectively reach the ears of the fetus, wherever the head of the fetus may happen to be presently in the uterus. The Field of Invention states: “More particularly, this invention pertains to a system for moving sound transmitters to positions most properly aligned with an unborn baby's ears.” This improvement, however, lacks in the very area where it aims to improve. By being fixed on a horizontal plane (the belt), the transmitters are not able to be moved independently of each other on askew angles relative to any given position of an unborn child's ears.

Therefore a need exists for an inexpensive, inconspicuous, and truly portable means to effectively convey sounds through the abdomen of a pregnant woman in a manner sufficiently flexible to accurately direct sounds toward the ears of the unborn child or to wherever may be most desired in the womb. The apparatus of the present invention, unlike the prior art, is believed to satisfy those needs.

### SUMMARY OF THE INVENTION

The invention is an apparatus for transmitting sounds through the abdominal wall of a pregnant woman for stimulation of the fetus. At least one sound transmitter is provided having sufficient power to transmit sounds through the abdominal wall of a pregnant woman, the sound transmitter being capable of receiving audio signals from an audio source. At least one housing partially surrounds each the sound transmitter and has associated therewith means for adhering the housing directly to the abdominal wall to place the sound transmitter in close proximity to the abdominal wall for transmission of sound therethrough. Preferably, two housings corresponding respectively to two sound transmitters are provided independently adherable to the abdominal wall.

Preferably, a means for limiting the maximum possible sound output level of the sound transmitter consistent with a level deemed safe for a developing fetus is included. The limiting means preferably includes a capacitor.

In one embodiment the housing preferably includes a concave inner surface which at least partially conform to the contours of a pregnant woman's abdomen. The adhering means preferably includes a silicone compound of the type that maintains a tacky surface and may be removed and reapplied to a surface multiple times. The silicone compound is preferably removably affixed to the housing, either via replacement rings on release paper, with intervening hook-and-loop-type fasteners such as Velcro®, or via other mechanisms.

Optionally, the device may include a signal splitter in communication with the audio source and an auxiliary sound transmitter receiving audio signals from the signal splitter and transmitting the audio signals substantially to the ears of the pregnant woman. In this way, the pregnant woman can listen to the same sounds as her unborn child.

The invention may also include an external case having a recess adapted to secure the housing when the housing is inserted therein. In this way, the adhesive may be protected between uses.

Alternatively, the invention is an apparatus for enabling transmission of sounds through the abdominal wall of a pregnant woman for stimulation of the fetus. At least one housing is provided having a recess adapted to receive at least one sound transmitter, such as a commercially available ear phone. The housing at least partially surrounds the sound transmitter when the sound transmitter is inserted into the recess. Means for adhering the housing directly to the abdominal wall place the sound transmitter in close proximity to the abdominal wall for transmission of sound therethrough.

As above, the at least one housing may include two housings each having one of the recesses adapted to receive a sound transmitter, with the two housings being independently adherable to the abdominal wall.

The housing preferably includes a concave inner surface which at least partially conform to the contours of a pregnant woman's abdomen.

Preferably, the means for adhering includes a silicone compound of the type that maintains a tacky surface and may be removed and reapplied to a surface multiple times. It may be removably affixed to the housing.

As above, this embodiment of the inventive device may include a signal splitter in communication with the audio source and an auxiliary sound transmitter receiving audio signals from the signal splitter and transmitting the audio signals substantially to the ears of the pregnant woman.

The invention includes a method and apparatus for exposing an unborn child to audio stimulation. In accordance with one embodiment of the present invention, modular, independent, limited-volume sound transmitters, joined to each other at one end by an audio plug, are encased in housings where is affixed an adhesive compound meant to provide the means for the transmitters to be held to the abdomen of the mother. Additionally, a separate audio jack is joined at or near the audio plug providing a means for the mother to listen simultaneously to the sounds being conveyed to the fetus.

The present invention complements the ubiquitous personal audio devices and commercially downloadable material available for auditory stimulation of a fetus by providing a means for mothers to transmit those sounds through the abdomen wall in a fashion vastly more elegant and effective than is possibly suggested in the prior art.

### BRIEF DESCRIPTION OF THE DRAWINGS

FIG. 1A-C are top, side, and bottom elevation views of a sound transmitting device in accordance with the invention.

FIG. 2 is an exploded side elevation view of the sound transmitting device of FIG. 1.

FIG. 3 is a perspective schematic of a sound transmitting device in accordance with the invention.

FIG. 4 is a perspective view of a sound transmitting device and an attendant carrying case in accordance with the invention.

FIG. 5 is another perspective view of the sound transmitting device and an attendant carrying case of FIG. 4.

FIG. 6 is a side elevation view of the sound transmitting device and an attendant carrying case of FIGS. 4 and 5.

FIGS. 7A-B are side elevation views of an alternate embodiment of a sound transmitting device in accordance with the invention.

FIG. 8 is a top elevation view of the sound transmitting device of FIG. 7.

FIG. 9 is a bottom elevation view of the sound transmitting device of FIGS. 7 and 8.

FIG. 10 is a schematic showing the use of one version of the invention.

FIG. 11 is a schematic showing the use of another version of the invention.

FIGS. 12A-C are schematics depicting a retaining strap for use with one embodiment of the invention.

### DETAILED DESCRIPTION OF THE PREFERRED EMBODIMENT AND DRAWINGS

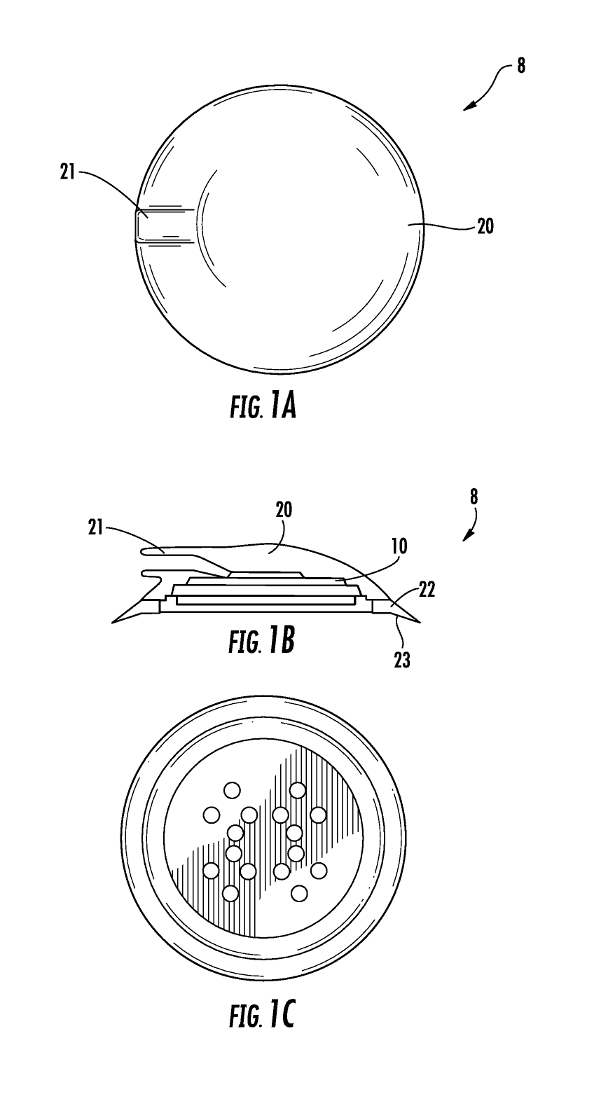

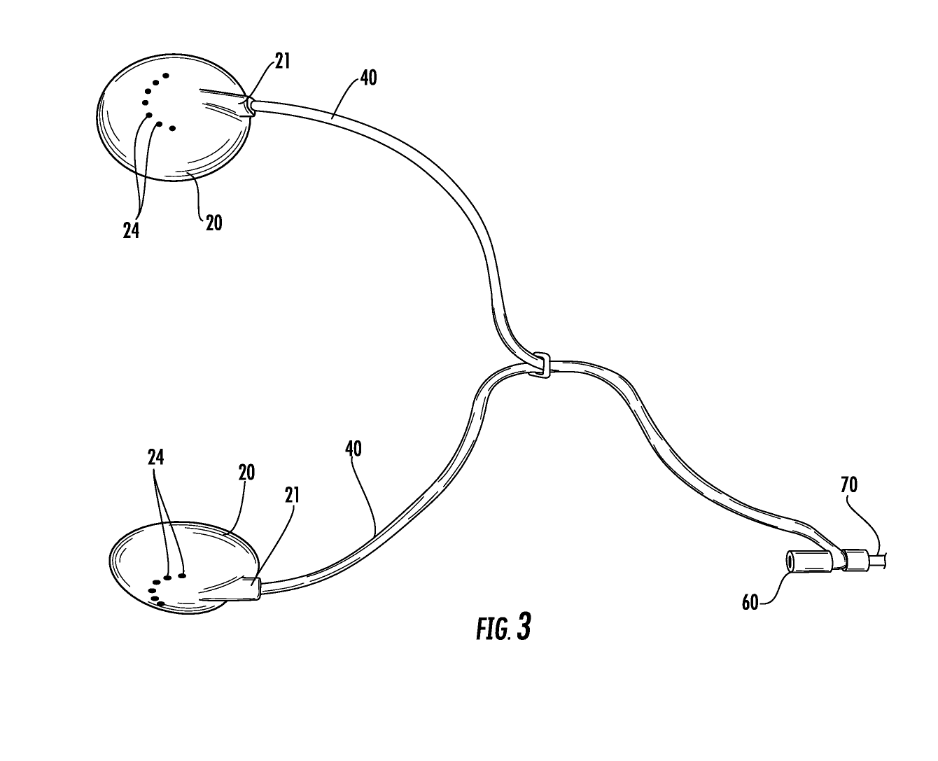

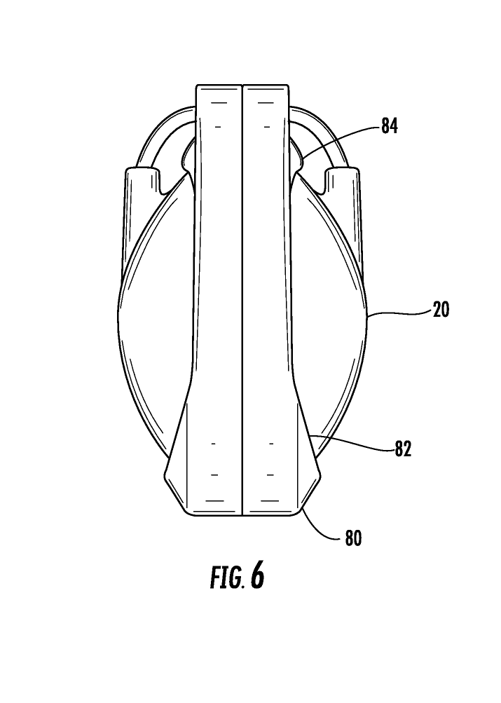

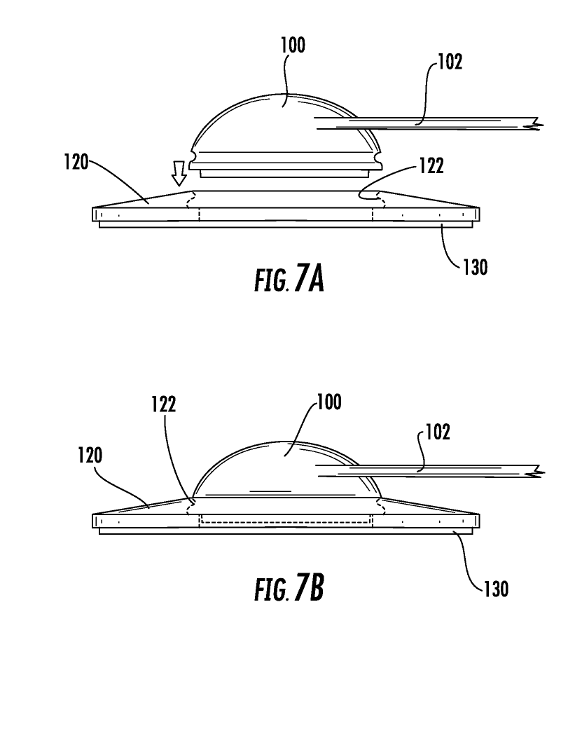

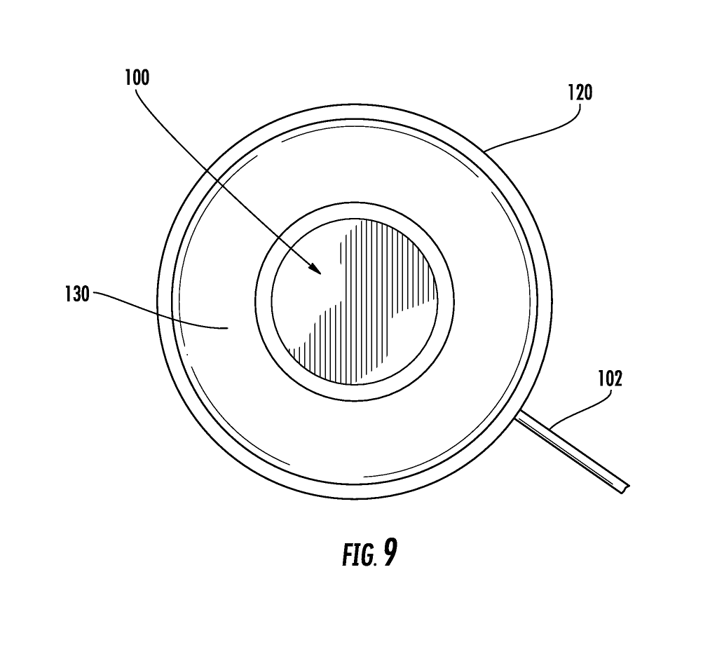

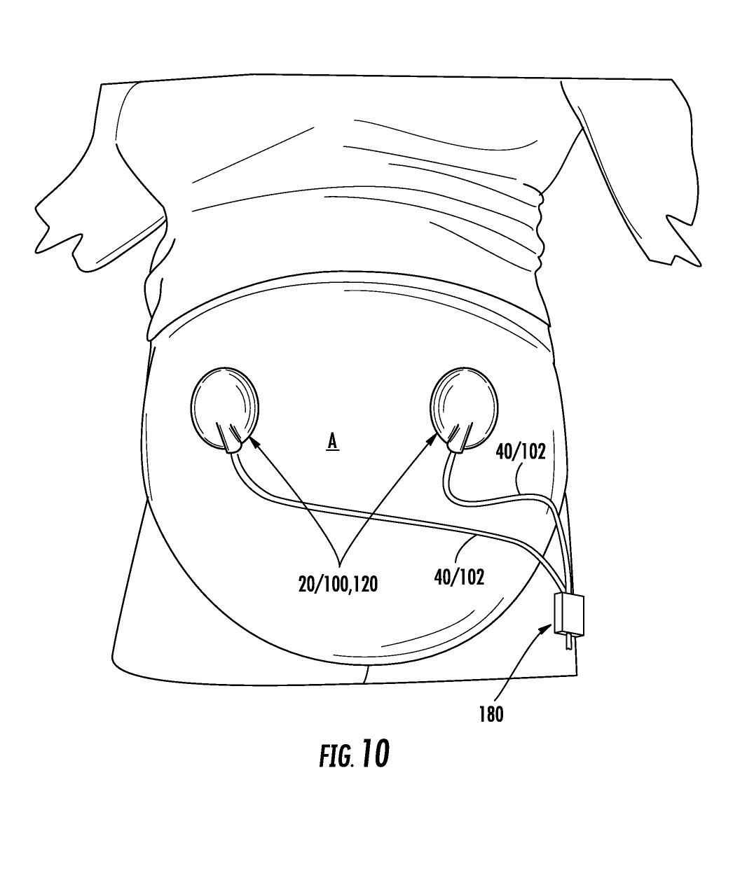

Description of the invention will now be given with reference to FIGS. 1-12. It should be understood that these figures are exemplary in nature and in no way serve to limit the scope of the invention, which is defined by the claims appearing hereinbelow.

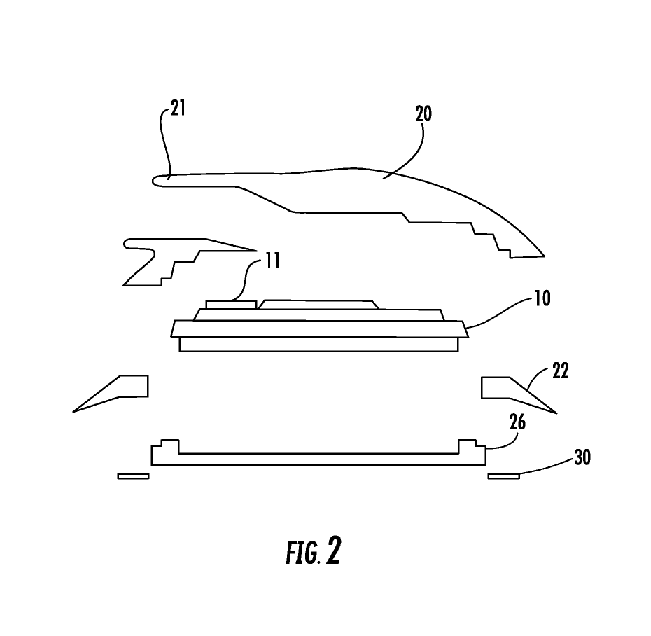

Referring to the drawings, there is disclosed an apparatus for transmitting sounds through the abdomen wall for the purpose of stimulating a fetus. The apparatus 8 includes at least one but preferably two sound transmitters 10 such as speakers encased within plastic housings 20 and connected electronically by a wire 40 (or, optionally, connected wirelessly) to an audio plug 70 and preferably an additional jack 60. The sound transmitters 10 are preferably connected to capacitors 111 (see FIG. 2) that control the maximum volume output of the apparatus. Each of the housings 20 has a substantially concave inner surface that is meant to lie against and thusly complement the contour of a pregnant belly. The outer surface has upon it a number of ventilation apertures 24 as well as a hollow stem 21 through which the wire 40 may pass through to the transmitter 10. Within the housings, the transmitters 10 are mounted with the speaker 10 facing downwardly away from concave inner surface of the housing 20 so that the sound may best be directed toward the abdomen. A speaker face plate 26 (see FIG. 2) may also be provided to protect the speaker of sound transmitter 10 from deleterious extended contact with the skin of the abdomen to which it is affixed as well as from any other potentially damaging contact from a finger or the like.

Affixed along the perimeter of the concave inner side of the housing 20 is an amount of silicon adhesive 30 for adhering the housing to the abdomen. The adhesive 30 is preferably deposited in an annular pattern, with the center open so as to best allow the sounds from the transmitter 10 to pass to the belly unobstructed. Along the circumference of the outer surface of the housing 20 is a rubber housing ring 22 with a flexible ridge 23. When the housing 20 is pressed to the belly, the flexible ridge 23 folds away from the belly allowing the adhesive 30 to contact and bond with the skin. When the housing 20 is removed from the abdomen, the flexible ridge 23 folds back down to its original position.

The two transmitters 10, being electronically connected and then joined together by the wire 40, end in a single audio plug 70 meant to be plugged into any standard personal music player. Molded together with the audio plug 70 is an audio jack 60 whereby a pair of headphones may be plugged into for the purpose of simultaneous listening by another person, e.g., by the pregnant woman, the expectant father, an ex utero sibling, etc.

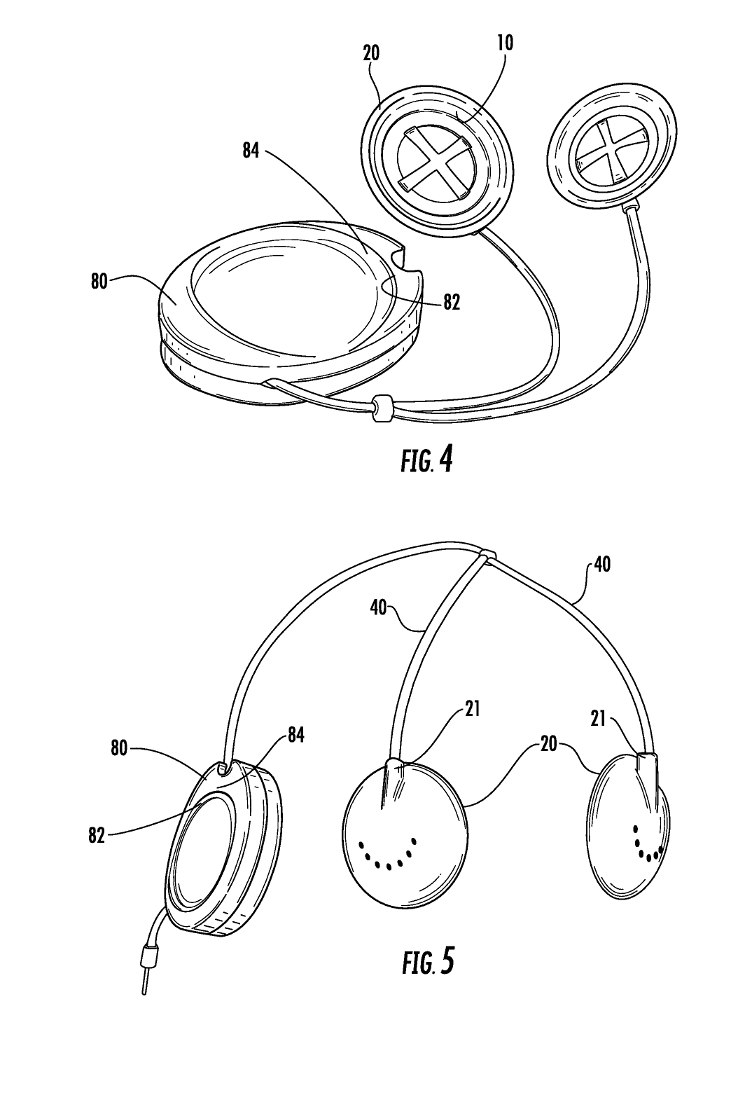

As best illustrated in FIGS. 4-6, a protective case 80 having two sides is connected to wire 40 running from the two sound transmitters 10. Case 80 includes on each side a recess 82 into which a housing 20 is configured to be disposed, with the adhesive 30 of housing 20 facing case 80. Recess 82 may include a detent 84 for firmly securing housing 20 within recess 82. When not in use, the housings 20 are meant to be placed respectively within recesses 82 with each concave inner side facing the other so that the two housings 20 are touching only along the circumference of the flexible ridge 23 of the housing rings 22. In this manner, the two housings form a protective environment (along with case 80) such that will keep the affixed rings of adhesive 30 safe from the elements and separate from each other.

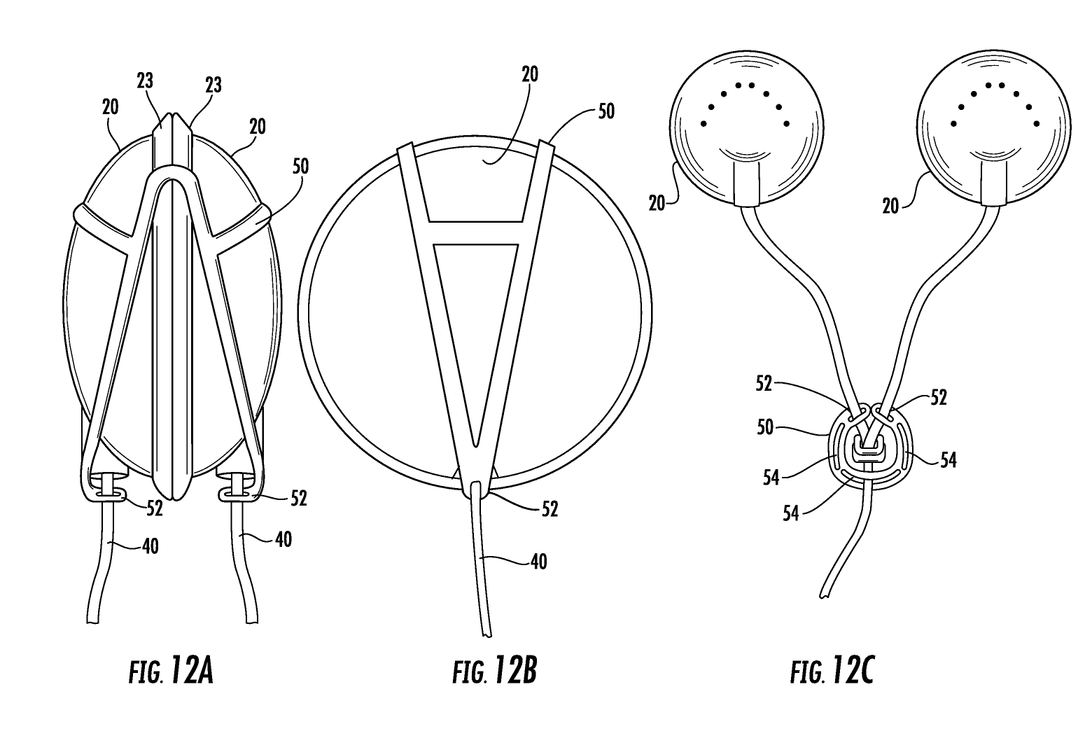

As an alternative to protective case 80 depicted in FIGS. 4-6, the inventive device 10 may be provided with a retaining strap or band 50 as shown in FIGS. 12A-C. FIGS. 12A-B are side and front elevation schematics depicting retaining strap or band 50 in a use configuration securing the two housings 20 of device 10 together, and FIG. 12C is a front elevation schematic showing retaining strap 50 in a non-use configuration. Strap or band 50 is preferably made from an elastic material (e.g., rubber or polymers with similar elastomeric properties as rubber) and is designed to be snugly secured about the two housings 20 when the housings are made to face each other along their respective perimetric flexible ridges 23. By securing the two housings 20 together, ridge 23 to ridge 23, the two housings form a protective casing that shields the adhesives 30 from the outside atmosphere and helps prevent the adhesive from drying out or getting damaged. Accordingly, by use of the retaining strap, a separate protective casing (such as the one shown in FIGS. 4-6) may be avoided, thereby reducing the manufacturing cost and the materials used.

Although a simple rubber band could accomplish the same task, inventive retaining strap 50 includes two loops 52 each secured around wires 40 so as to prevent the user from losing strap 50. One or more openings 54 may be provided in strap 50, at least one of which is designed to fit around an edge of housings 20 when they are facing each other (as shown in FIGS. 12A and B). Since the material is preferably elastic, opening 54 is stretched around housings 20 and secures them together.

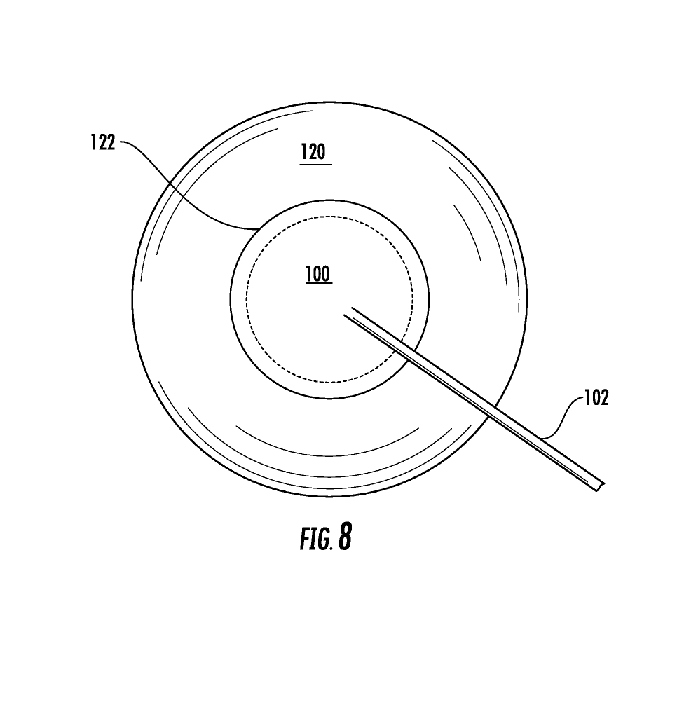

An alternative embodiment is shown in FIGS. 7-9. Here, conventional commercially available ear buds 100 having wires 102 are securable within recesses 122 of housings 120. Housing 120 includes a corresponding adhesive 130, preferably annular in shape as above. In this way, the invention can retrofit an existing pair of earphones or ear buds to be usable advantageously upon the belly of a pregnant woman without requiring the use of prior art belts or straps that would impede her mobility.

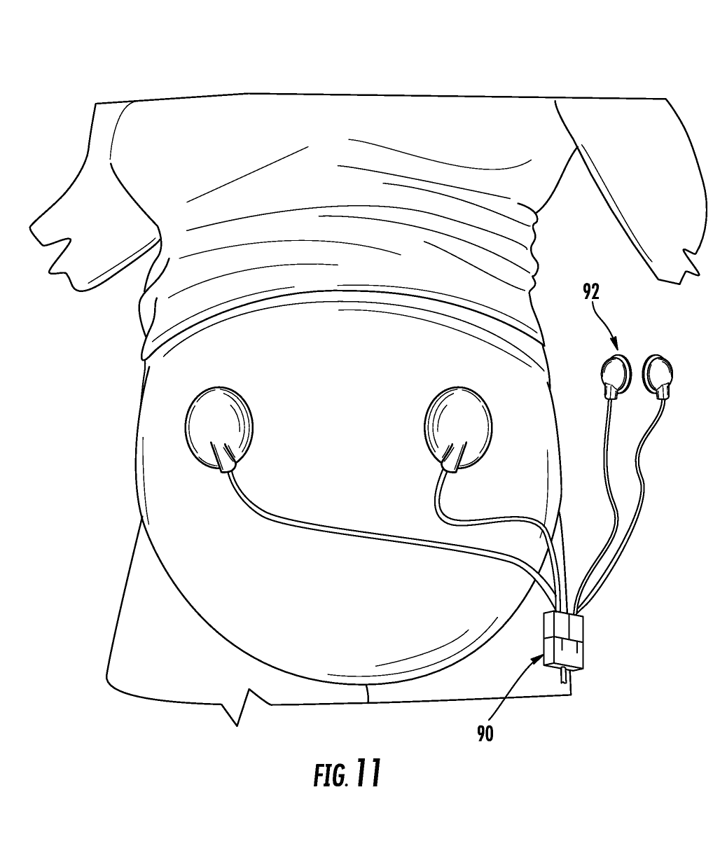

In operation, either embodiment of the invention works as shown in FIG. 10, for example. Housings 20/120 are affixed to the abdomen A of a pregnant woman via adhesive 30/130. Sound transmitters 10/100 are connected to audio source 180 (e.g., a mp3 player) via wires 40/102, although the sound transmitters could be connected to audio source 180 via known wireless transmission methods. The user can select music, speech from a family member, or other sounds to play on the audio source 180, and the sound is transmitted directly to her abdomen and thence to the fetus therein. Unlike using prior art methods and devices, use of the invention enables the pregnant woman full range of mobility, and she can walk, jog, run, bicycle, perform errands, or the like (assuming she is cleared to do so by her obstetrician). FIG. 11 depicts a modification to the main embodiment. Here, the audio source (not shown in FIG. 11) includes a signal splitter 90 which sends audio signals to auxiliary sound transmitters 92, e.g., ear buds or earphones. This allows the user to listen to what the fetus is listening to. Optionally, additional or different audio information may be provided to the ex utero listener via auxiliary sound transmitters 92.

While the above description contains much specificity, this should not be construed as a limitation on the scope of any embodiment, but as an exemplification of the presently preferred embodiment thereof. Many other ramifications and variations are possible within the teachings of the various embodiments. For example, another embodiment of the present invention might have one or more than two sound transmitters and the transmitters themselves, as well as their respective housings, may be of greater or lesser size, any variety of colors, and varying shape. Still another embodiment might be a wireless version of the present embodiment that takes advantage of the current and quickly progressing technology that provides a way to connect and exchange information between electronic devices over a secure, globally unlicensed short-range radio frequency. An alternative variation of the apparatus might also lack the audio jack meant for simultaneous listening or said jack may be located or connected to the apparatus in a different fashion. The present embodiment might also be adapted so that the adhesive affixed casing might exist as a removable attachment for existing commercial headphones/earbuds allowing said headphones/earbuds instead to adhere to the wall of the abdomen where they may likewise function to convey sounds to a fetus.

As another alternative, the adhesive itself may be removable from the housing and replacable when it becomes worn or insufficiently sticky. For example, the invention may be sold with replacement rings of adhesive mounted on release paper or another similar medium. Also, the adhesive rings may be mounted on a ring of plastic or metal that would snap fit into place on the housing and would thus be easily replacable when needed. As another option, one side of a hook and loop fastener such as Velcro® may be provided on the housing and the adhesive may be provided on a substrate having the other side of the hook and loop fastener. In this embodiment, the user would affix the substrate to her abdomen via the adhesive and then would affix the housing to the substrate via the hook and loop fastener. Other versions of this concept may be employed.

Having described certain embodiments of the invention, it should be understood that the invention is not limited to the above description or the attached exemplary drawings. Rather, the scope of the invention is defined by the claims appearing hereinbelow and any equivalents thereof as would be appreciated by one of ordinary skill in the art.

What is claimed is:

1. Apparatus for transmitting sounds through the abdominal wall of a pregnant woman for stimulation of the fetus, comprising:
at least one sound transmitter having sufficient power to transmit sounds through the abdominal wall of a pregnant woman, said sound transmitter capable of receiving audio signals from an audio source;
at least one housing that at least partially surrounds each said sound transmitter; and
means for adhering said housing directly to the abdominal wall to place said sound transmitter in close proximity to said abdominal wall for transmission of sound therethrough.

2. An apparatus according to claim 1, wherein said at least one housing comprises two of said housings, and wherein said at least one sound transmitter further comprises two of said sound transmitters, said two housings being independently adherable to the abdominal wall.

3. An apparatus according to claim 1, further comprising a means for limiting the maximum possible sound output level of said sound transmitter consistent with a level deemed safe for a developing fetus.

4. An apparatus according to claim 3, wherein said limiting means comprises a capacitor.

5. An apparatus according to claim 1, wherein said housing comprises a concave inner surface which at least partially conform to the contours of a pregnant woman's abdomen.

6. An apparatus according to claim 1, wherein said means for adhering comprises a silicone compound of the type that maintains a tacky surface and may be removed and reapplied to a surface multiple times.

7. An apparatus according to claim 7, wherein said silicone compound is removably affixed to said housing.

8. An apparatus according to claim 1, further comprising:
a signal splitter in communication with the audio source; and
an auxiliary sound transmitter receiving audio signals from said signal splitter and transmitting said audio signals substantially to the ears of a person.

9. An apparatus according to claim 2, further comprising an external case having a recess adapted to secure said housing when said housing is inserted therein.

10. An apparatus according to claim 2, further comprising a restraining strap adapted to secure said two housings together contacting each other only along respective outer perimeters of said housings, thereby forming a cavity between said housings in which said adhesives are protected.

11. Apparatus for enabling transmission of sounds through the abdominal wall of a pregnant woman for stimulation of the fetus, comprising:
at least one housing having a recess adapted to receive at least one sound transmitter, said housing at least partially surrounding the sound transmitter when the sound transmitter is inserted into said recess; and
means for adhering said housing directly to the abdominal wall to place the sound transmitter in close proximity to said abdominal wall for transmission of sound therethrough.

12. Apparatus according to claim 11, wherein said at least one housing comprises two of said housings each having one of said recesses adapted to receive a sound transmitter, wherein said two housings are independently adherable to the abdominal wall.

13. An apparatus according to claim 11, wherein said housing comprises a concave inner surface which at least partially conform to the contours of a pregnant woman's abdomen.

14. An apparatus according to claim 11, wherein said means for adhering comprises a silicone compound of the type that maintains a tacky surface and may be removed and reapplied to a surface multiple times.

15. The means for adhering of claim 14, wherein said silicone compound is removably affixed to said housing.

16. An apparatus according to claim 11, wherein the sound transmitter receives audio signals from an audio source, said apparatus further comprising:
a signal splitter in communication with the audio source; and
an auxiliary sound transmitter receiving audio signals from said signal splitter and transmitting said audio signals substantially to the ears of a person.

17. An apparatus according to claim 12, further comprising a restraining strap adapted to secure said two housings together contacting each other only along respective outer perimeters of said housings, thereby forming a cavity between said housings in which said adhesives are protected.
